(19) United States
(12) Patent Application Publication
(10) Pub. No.: US 2025/0150944 A1
(43) Pub. Date: May 8, 2025

(54) METHOD AND APPARATUS FOR MONITORING DOWNLINK BANDWIDTH PART, AND READABLE STORAGE MEDIUM

(71) Applicant: Beijing Xiaomi Mobile Software Co., Ltd., Beijing (CN)

(72) Inventor: Qin MU, Beijing (CN)

(73) Assignee: Beijing Xiaomi Mobile Software Co., Ltd., Beijing (CN)

(21) Appl. No.: 18/838,108

(22) PCT Filed: Feb. 14, 2022
(86) PCT No.: PCT/CN2022/076259

§ 371 Date: Aug. 13, 2024

(51) Int. Cl. H04W 48/12; H04W 68/00; H04W 74/00

(52) U.S. Cl. CPC H04W 48/12; H04W 68/00; H04W 74/006

(57) ABSTRACT

A method and apparatus for monitoring a downlink bandwidth part (BWP), and a readable storage medium, which are applied to the technical field of wireless communications. The method comprises: monitoring N first-type initial downlink BWPs, wherein N is not greater than M; the first-type initial downlink BWPs are initial downlink BWPs specific to a first-type terminal; and N and M are integers greater than 0, and M indicates the maximum number of the first-type initial downlink BWPs that can be configured by a network device for the first-type terminal.

### CROSS-REFERENCE TO RELATED APPLICATION

The present application is a U.S. National Stage of International Application No. PCT/CN2022/076259, filed on Feb. 14, 2022, the contents of which are incorporated herein by reference in their entirety.

### TECHNICAL FIELD

The present disclosure relates to the field of wireless communication technologies, and in particular, to a method, apparatus and readable storage medium for monitoring a downlink bandwidth part.

### BACKGROUND

In a long term evolution (LTE) system, machine type communication (MTC) technology and narrow band internet of things (NB-IoT) technology are proposed to support internet of things (IoT) services. These two technologies are mainly aimed at low-speed and high-delay scenarios, such as meter reading and environmental monitoring. At present, MTC can only support a maximum transmission rate of a few megabytes (MB), and NB-IoT can only support a maximum transmission rate of a few hundred kilobytes (kB).

With the continuous development of Internet of Things services, services such as video surveillance, smart home, wearable devices and industrial sensor monitoring are becoming more and more popular. These services usually require tens to 100 MB transmission rate and also have relatively high latency requirements, so MTC technology and NB-IoT technology are difficult to meet these requirements. Therefore, it is proposed to design a new terminal type in 5G new radio (NR) to cover mid-range IoT devices. In the current 3GPP standardization, this new terminal type is named as reduced capability UE, or Redcap terminal, or NR-lite for short. Moreover, similar to IoT devices in LTE, such new terminals typically need to meet the requirements of low cost, low complexity, some degree of coverage enhancement, and power savings.

In order to meet the requirements of low cost and low complexity, it is possible to limit an RF bandwidth of the NR-lite, e.g., to 20 MHz, or to limit a buffer size of NR-lite, and then limit a size of each received transmission block. For power saving, a possible optimization direction is to simplify communication processes and reduce the number of times NR-lite users detect downlink control channels.

How to further improve the performance of NR-lite is a technical problem to be solved.

### SUMMARY

In a first aspect, a method of monitoring a downlink bandwidth part (BWP) is provided, which is performed by a first-type terminal, including: monitoring N first-type initial downlink BWPs, where the N is not greater than M, the first-type initial downlink BWPs are initial downlink BWPs specific to the first-type terminal, the N and the M are integers greater than 0, and the M indicates a maximum number of the first-type initial downlink BWPs configurable by a network device for the first-type terminal.

In a second aspect, a method of monitoring a downlink BWP is provided, which is performed by a network device, including: sending first configuration information to a first-type terminal, where the first configuration information relates to N first-type initial downlink BWPs to be monitored by the first-type terminal; where the N is not greater than M, the first-type initial downlink BWPs are initial downlink BWPs specific to the first-type terminal, the N and the M are integers greater than 0, and the M indicates a maximum number of first-type initial downlink BWPs configurable by the network device for the first-type terminal.

In a third aspect, a communication apparatus is provided, that includes a processor and a memory, the memory is configured to store a computer program, and the processor is configured to monitor N first-type initial downlink BWPs, where the N is not greater than M, the first-type initial downlink BWPs are initial downlink BWPs specific to the first-type terminal, the N and the M are integers greater than 0, and the M indicates a maximum number of the first-type initial downlink BWPs configurable by a network device for the first-type terminal.

### BRIEF DESCRIPTION OF DRAWINGS

The accompanying drawings described herein are provided to provide a further understanding of embodiments of the present disclosure and constitute a part of the present disclosure. Illustrative embodiments of the embodiments of the present disclosure and their descriptions are used to explain the embodiments of the present disclosure and do not constitute improper limitations on the embodiments of the present disclosure. In the accompanying drawings:

the accompanying drawings, which are incorporated in and constitute a part of the specification, illustrate embodiments consistent with the embodiments of the present disclosure, and are used together with the specification to explain the principles the embodiments of the present disclosure.

FIG. 1 is a schematic architectural diagram of a wireless communication system according to an embodiment of the present disclosure.

FIG. 2 is a flowchart of a method of monitoring a downlink BWP according to an embodiment of the present disclosure.

FIG. 3 is a schematic diagram of configuring an initial downlink BWP according to an embodiment of the present disclosure.

FIG. 4 is a flowchart of a method of monitoring a downlink BWP according to an embodiment of the present disclosure.

FIG. 5 is a flowchart of a method of monitoring a downlink BWP according to an embodiment of the present disclosure.

FIG. 6 is a flowchart of a method of monitoring a downlink BWP according to an embodiment of the present disclosure.

FIG. 7 is a flowchart of a method of monitoring a downlink BWP according to an embodiment of the present disclosure.

FIG. 8 is a flowchart of a method of monitoring a downlink BWP according to an embodiment of the present disclosure.

FIG. 9 is a flowchart of a method of monitoring a downlink BWP according to an embodiment of the present disclosure.

FIG. 10 is a flowchart of a method of monitoring a downlink BWP according to an embodiment of the present disclosure.

FIG. 11 is a structural diagram of an apparatus for monitoring a downlink BWP according to an embodiment of the present disclosure.

FIG. 12 is a structural diagram of an apparatus for monitoring a downlink BWP according to an embodiment of the present disclosure.

FIG. 13 is a structural diagram of an apparatus for monitoring a downlink BWP according to an embodiment of the present disclosure.

FIG. 14 is a structural diagram of an apparatus for monitoring a downlink BWP according to an embodiment of the present disclosure.

### DETAILED DESCRIPTION

Embodiments of the present disclosure are further described in connection with the accompanying drawings and specific embodiments.

Reference will now be made in detail to embodiments of the present disclosure, examples of which are illustrated in the accompanying drawings. When the following description refers to the accompanying drawings, unless otherwise indicated, the same numbers in different accompanying drawings indicate the same or similar elements. Implementations described in the following embodiments of the present disclosure do not represent all implementations consistent with the embodiments of the present disclosure. Rather, they are merely examples of apparatuses and methods consistent with some aspects of the present disclosure as detailed in the appended claims.

Terms used in embodiments of the present disclosure are only for a purpose of describing specific embodiments, and are not limiting the embodiments of the present disclosure. Singular forms of “a”, said ”, and “the” used in the embodiments of the present disclosure and in the claims are also intended to include majority forms, unless the context clearly indicates otherwise. It should also be understood that the term “and/or” as used herein refers to any or all of the possible combinations containing one or more of the listed items in association.

It should be understood that although terms first, second, third, etc. may be used to describe various information in the embodiments of the present disclosure, this information should not be limited to these terms. These terms are used only to distinguish the same type of information from one another. For example, without departing from the scope of the present disclosure, first information can also be named as second information, and similarly, the second information can also be named as the first information. Depending on the context, the word “in a case that” and “If” as used herein can be interpreted as “at” or “when” or “in response to determining”.

Hereinafter, embodiments of the present disclosure will be described in detail, examples of which are illustrated in the accompanying drawings, where the same or similar reference numerals indicate the same or similar elements throughout. Embodiments described below by referring to the accompanying drawings are examples and are intended to explain the present disclosure, and should not be construed as limiting the present disclosure.

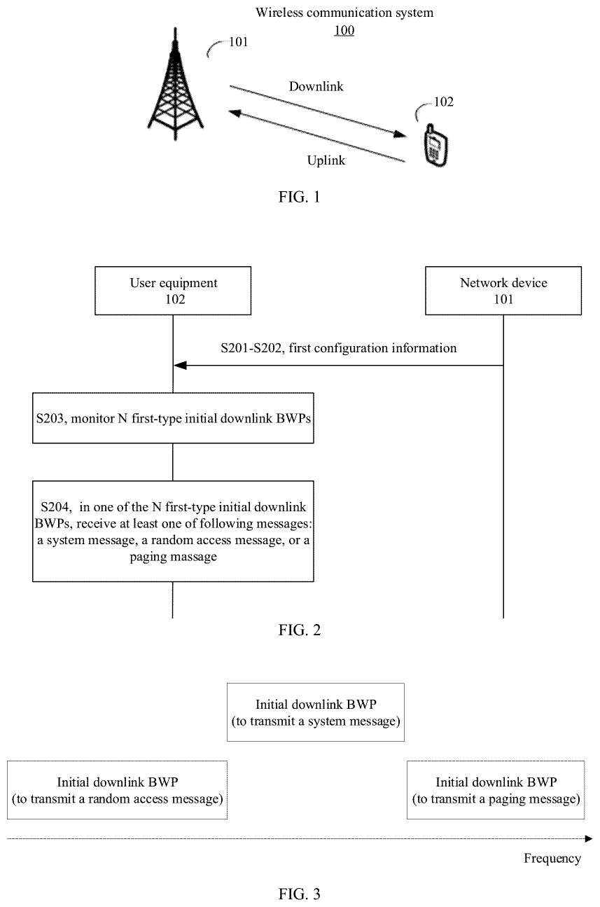

As shown in FIG. 1, a wireless communication system 100, which may include, but is not limited to, a network device 101 and a user equipment 102, can perform a method of monitoring a downlink BWP provided by an embodiment of the present disclosure. The user equipment 102 is configured to support carrier aggregation, and the user equipment 102 can be connected to a plurality of carrier units of the network device 101, including a primary carrier unit and one or more secondary carrier units.

It should be understood that the wireless communication system 100 can be applied to both low-frequency and high-frequency scenarios. Application scenarios of the wireless communication system 100 include, but are not limited to, a long term evolution (LTE) system, a frequency division duplex (FDD) system, an LTE time division duplex (TDD) system, a worldwide interoperability for micro wave access (WiMAX) communication system, a cloud radio access network (CRAN) system, a future 5th-Generation (5G) system, a new radio (NR) communication system or a future evolved public land mobile network (PLMN) system, etc.

The user equipment 102 shown may be a user equipment (UE), a terminal, an access terminal, a terminal unit, a terminal station, a mobile station (MS), a remote station, a remote terminal, a mobile terminal, a wireless communication device, a terminal agent, or a user device, and the like. The user equipment 102 may have a wireless transceiving function, and it can communicate with one or more network devices 101 of one or more communication systems 100 (such as wireless communication) and accept network services provided by the network devices 101, and the network device 101 here includes but not limited to the base station shown in FIG. 1.

The user equipment 102 can be a cellular phone, a cordless phone, a session initiation protocol (SIP) phone, a wireless local loop (WLL) station, a personal digital assistant (PDA) device, a handheld device with wireless communication function, a computing device or other processing device connected to a wireless modem, a vehicle mounted device, a wearable device, a user device in future 5G networks, or a user device in future evolved PLMN networks, etc.

The network device 101 may be an access network device (or an access network point). The access network device refers to a device that provides network access functions, such as a radio access network (RAN) base station and so on. The network device 101 may specifically include a base station (BS) device, or include a base station device and a radio resource management device for controlling the base station device. The network device 101 may further include a relay station (relay equipment), an access point, and a base station in future 5G networks, a base station in future evolved PLMN networks or an NR base station. The network device 101 can be a wearable device or a vehicle-mounted device. The network device 101 can also be a communication chip with a communication module.

For example, the network device 101 may include, but is not limited to, a next-generation base station (gnodeB, gNB) in 5G, an evolved node B (eNB) in an LTE system, a radio network controller (RNC), a node B (NB) in a WCDMA system, a radio controller in a CRAN system, a base station controller (BSC), a base transceiver station (BTS) in a GSM system or a CDMA system, a home base station (e.g., home evolved nodeB, or home node B, HNB), a baseband unit (BBU), a transmitting and receiving point (TRP), a transmitting point (TP), or a mobile switching center.

The user equipment 102 may include a first-type terminal and a second-type terminal, where the first-type terminal may be a reduced capacity terminal (RedCap UE), and the second-type terminal may be an ordinary terminal (named as a Legacy UE or named as a non-RedCap UE) or an enhanced mobile broadband (eMBB) terminal. A terminal capability of the first-type terminal is less than that of the second-type terminal, e.g., a bandwidth supported by the first-type terminal is smaller than a bandwidth supported by the second-type terminal.

An embodiment of the present disclosure provides a method of reporting user equipment capabilities. FIG. 2 is a flowchart of a method for transmitting downlink information according to an embodiment of the present disclosure. As shown in FIG. 2, the method includes the following steps, S201-S204.

At step S201: first configuration information is sent to a first-type terminal, where the first configuration information relates to N first-type initial downlink BWPs to be monitored by the first-type terminal; where the N is not greater than M, the first-type initial downlink BWPs are initial downlink BWPs specific to the first-type terminal, the N and the M are integers greater than 0, and the M indicates a maximum number of the first-type initial downlink BWPs configurable by a network device 101 for the first-type terminal.

At step S202: the first-type terminal receives the first configuration information.

At step S203: the N first-type initial downlink BWPs are monitored by the first-type terminal, where the N is not greater than the M, the first-type initial downlink BWPs are initial downlink BWPs specific to the first-type terminal, the N and the M are integers greater than 0, and the M indicates the maximum number of first-type initial downlink BWPs configurable by the network device for the first-type terminal.

At step S204: at least one of following messages: a system message, a random access message, or a paging massage is received by the first-type terminal in one of the N first-type initial downlink BWPs.

In some possible implementations, the first-type terminal is a Redcap terminal.

In some possible implementations, the M is not greater than 3.

In some possible implementations, as shown in FIG. 3, the maximum number of first-type initial downlink BWPs that can be configured by the network device 101 for the first-type terminal is 3, where the three first-type initial downlink BWPs that can be configured by the network device for the first-type of terminal are used to send a paging message, to send a random access message, and to send a system message, respectively.

In some possible implementations, the M is 1.

In an embodiment of the present disclosure, the first-type initial downlink BWPs to be monitored by the first-type terminal are reduced, thereby reducing the complexity of the first-type terminal and saving the power of the first-type terminal.

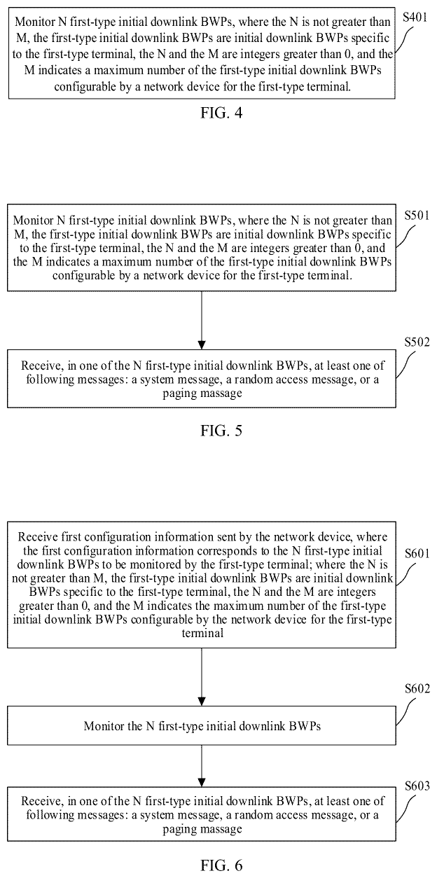

An embodiment of the present disclosure provides a method of receiving downlink information, which is performed by a first-type terminal. FIG. 4 is a flowchart of a method of receiving downlink information according to an embodiment of the present disclosure. As shown in FIG. 4, the method includes the following step S401.

At step S401: N first-type initial downlink BWPs are monitored, where the N is not greater than M, the first-type initial downlink BWPs are initial downlink BWPs specific to the first-type terminal, the N and the M are integers greater than 0, and the M indicates a maximum number of the first-type initial downlink BWPs configurable by a network device for the first-type terminal.

In some possible implementations, the first-type terminal is a Redcap terminal.

In some possible implementations, the M is not greater than 3.

In some possible implementations, as shown in FIG. 3, the maximum number of first-type initial downlink BWPs that can be configured by the network device for the first-type terminal is 3, where the three first-type initial downlink BWPs that can be configured by the network device for the first-type of terminal are used to send a paging message, to send a random access message, and to send a system message, respectively.

In some possible implementations, the M is 1.

In some possible implementations, configuration information relating to K second-type initial downlink BWPs to be monitored by the first-type terminal is determined according to a definition of a protocol.

In some possible implementations, configuration information relating to K second-type initial downlink BWPs to be monitored by the first-type terminal is configured by the network device 101.

In the embodiment of the present disclosure, the first-type initial downlink BWPs to be monitored by the first-type terminal are reduced, thereby reducing the complexity of the first-type terminal and saving the power of the first-type terminal.

An embodiment of the present disclosure provides a method of receiving downlink

information, which is performed by a first-type terminal. FIG. 5 is a flowchart of a method of receiving downlink information according to an embodiment of the present disclosure. As shown in FIG. 5, the method includes the following steps, S501 and S502.

At step S501: N first-type initial downlink BWPs are monitored, where the N is not greater than M, the first-type initial downlink BWPs are initial downlink BWPs specific to the first-type terminal, the N and the M are integers greater than 0, and the M indicates a maximum number of the first-type initial downlink BWPs configurable by a network device 101 for the first-type terminal.

At step S502: at least one of following messages: a system message, a random access message, or a paging massage is received in one of the N first-type initial downlink BWPs.

In some possible implementations, the first-type terminal is a Redcap terminal. In some possible implementations, the M is not greater than 3.

In some possible implementations, as shown in FIG. 3, the maximum number of first-type initial downlink BWPs that can be configured by the network device for the first-type terminal is 3, where the three first-type initial downlink BWPs that can be configured by the network device for the first-type of terminal are used to send a paging message, to send a random access message, and to send a system message, respectively.

In some possible implementations, the M is 1.

In some possible implementations, in step S502, a system message, a random access message, and a paging message are received in one of the N first-type initial downlink BWPs. That is, the system message, the random access message, and the paging message are received in the same first-type initial downlink BWP.

In some possible implementations, configuration information relating to K second-type initial downlink BWPs to be monitored by the first-type terminal is determined according to a definition of a protocol.

In some possible implementations, configuration information relating to K second-type initial downlink BWPs to be monitored by the first-type terminal is configured by the network device 101.

In the embodiment of the present disclosure, the first-type initial downlink BWPs to be monitored by the first-type terminal are reduced, thereby reducing the complexity of the first-type terminal and saving the power of the first-type terminal.

An embodiment of the present disclosure provides a method of receiving downlink information, which is performed by a first-type terminal. FIG. 6 is a flowchart of a method of receiving downlink information according to an embodiment of the present disclosure. As shown in FIG. 6, the method includes the following steps, S601-S603.

At step S601: first configuration information sent by the network device is received, where the first configuration information relates to the N first-type initial downlink BWPs to be monitored by the first-type terminal; where the N is not greater than M, the first-type initial downlink BWPs are initial downlink BWPs specific to the first-type terminal, the N and the M are integers greater than 0, and the M indicates the maximum number of the first-type initial downlink BWPs configurable by the network device 101 for the first-type terminal.

At step S602: the N first-type initial downlink BWPs are monitored.

At step S603: at least one of following messages: a system message, a random access message, or a paging massage is received in one of the N first-type initial downlink BWPs.

In some possible implementations, the first-type terminal is a Redcap terminal.

In some possible implementations, the M is not greater than 3.

In some possible implementations, as shown in FIG. 3, the maximum number of first-type initial downlink BWPs that can be configured by the network device for the first-type terminal is 3, where the three first-type initial downlink BWPs that can be configured by the network device for the first-type of terminal are used to send a paging message, to send a random access message, and to send a system message, respectively.

In some possible implementations, the M is 1.

In some possible implementations, step S603 is further included, in which at least one of the following messages: a system message, a random access message, or a paging message is received in one of the N first-type initial downlink BWPs.

In an example, a system message, a random access message, and a paging message are received in one of the N first-type initial downlink BWPs. That is, the system message, the random access message, and the paging message are received in the same first-type initial downlink BWP.

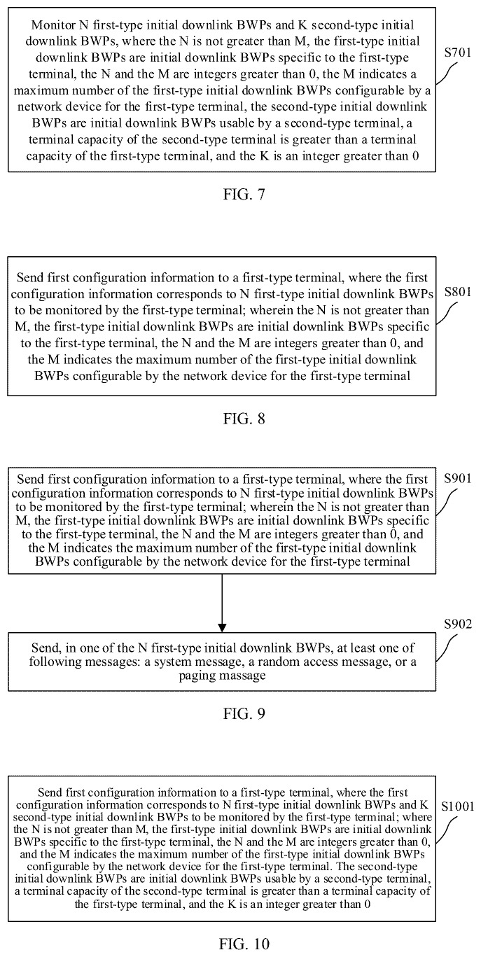

An embodiment of the present disclosure provides a method of receiving downlink information, which is performed by a first-type terminal. FIG. 7 is a flowchart of a method of receiving downlink information according to an embodiment of the present disclosure. As shown in FIG. 7, the method includes the following step S701.

At step S701: N first-type initial downlink BWPs and K second-type initial downlink BWPs are monitored, where the N is not greater than M, the first-type initial downlink BWPs are initial downlink BWPs specific to the first-type terminal, the N and the M are integers greater than 0, and the M indicates a maximum number of the first-type initial downlink BWPs configurable by a network device for the first-type terminal. The K second-type initial downlink BWP is an initial downlink BWP that can be configured for use by both a first-type terminal and a second-type terminal, a terminal capacity of the second-type terminal is greater than a terminal capacity of the first-type terminal, and the K is an integer greater than 0.

In some possible implementations, the first-type terminal is a Redcap terminal. The second-type terminal is a 5G terminal.

In some possible implementations, the M is not greater than 3.

In some possible implementations, as shown in FIG. 3, the maximum number of first-type initial downlink BWPs that can be configured by the network device for the first-type terminal is 3, where the three first-type initial downlink BWPs that can be configured by the network device for the first-type of terminal are used to send a paging message, to send a random access message, and to send a system message, respectively.

In some possible implementations, the M is 1.

In some possible implementations, the K is not greater than 1.

In some possible implementations, configuration information relating to K second-type initial downlink BWPs to be monitored by the first-type terminal is determined according to a definition of a protocol.

In some possible implementations, configuration information relating to K second-type initial downlink BWPs to be monitored by the first-type terminal is configured by the network device.

In some possible examples, before step S701, the method further includes: receiving first configuration information sent by the network device 101, where the first configuration information relates to the N first-type initial downlink BWPs to be monitored by the first-type terminal, and further relates to the K second-type initial downlink BWPs to be monitored by the first-type terminal. The N is not greater than M, the first-type initial downlink BWPs are initial downlink BWPs specific to the first-type terminal, the N and the M are integers greater than 0, and the M indicates the maximum number of first-type initial downlink BWPs configurable by the network device for the first-type terminal. The second-type initial downlink BWPs are initial downlink BWPs usable by a second-type terminal, a terminal capacity of the second-type terminal is greater than a terminal capacity of the first-type terminal, and the K is an integer greater than 0.

In some possible implementations, in step S701, one of the N first-type initial downlink BWPs corresponds to at least one of the following messages: a system message, a random access message, or a paging message.

The method further includes: receiving a system message, a random access message, and a paging message in one of the N first-type initial downlink BWPs.

In a possible example, in step S701, one of the N first-type initial downlink BWPs corresponds to a system message, a random access message, and a paging message. That is, the same first-type initial downlink BWP corresponds to the system message, the random access message, and the paging message.

The method further includes: receiving a system message, a random access message, and a paging message in one of the N first-type initial downlink BWPs. That is, the system message, the random access message, and the paging message are received in the same first-type initial downlink BWP.

In some possible implementations, in step S701, one of the K second-type initial downlink BWPs corresponds to at least one of the following messages: a system message, a random access message, or a paging message.

The method further includes: receiving, in one of the K second-type initial downlink BWPs, at least one of following messages: a system message, a random access message, or a paging message.

In a possible example, in step S701, one of the K second-type initial downlink BWPs corresponds to a system message, a random access message, and a paging message. That is, the same second-type initial downlink BWP corresponds to the system message, the random access message, and the paging message.

The method further includes: receiving a system message, a random access message, and a paging message in one of the K second-type initial downlink BWPs. That is, the system message, the random access message, and the paging message are received in the same second-type initial downlink BWP.

In some possible implementations, in step S701, one of the N first-type initial downlink BWPs corresponds to a random access message. One of the K second-type initial downlink BWPs corresponds to a system message and a paging message, or, one of the K second-type initial downlink BWPs corresponds to a system message, and another second-type initial downlink BWP corresponds to a paging message.

The method further includes: receiving a random access message in one of the N first-type initial downlink BWPs, and receiving a system message and a paging message in one or two of the K second-type initial downlink BWPs.

Specifically, one of the K second-type initial downlink BWPs receives a system message and a paging message. Or, a system message is received in one of the K second-type initial downlink BWPs and a paging message is received in another second-type initial downlink BWP.

In some possible implementations, in step S701, one of the N first-type initial downlink BWPs corresponds to a random access message and a paging message. One of the K second-type initial downlink BWPs corresponds to a system message.

The method further includes: receiving a random access message and a paging message in one of the N first-type initial downlink BWPs, and receiving a system message in one of the K second-type initial downlink BWPs.

In some possible implementations, in step S701, two of the N first-type initial downlink BWPs respectively correspond to a random access message and a paging message, and one of the K second-type initial downlink BWPs corresponds to a system message.

The method further includes: receiving a random access message and a paging message in two of the N first-type initial downlink BWPs respectively, and receiving a system message in one of the K second-type initial downlink BWPs.

In some possible implementations, in step S701, one of the N first-type initial downlink BWPs corresponds to a paging message, and one or two of the K second-type initial downlink BWPs corresponds to a random access message and a system message.

One of the K second-type initial downlink BWPs corresponds to a random access message and a system message, or one of the K second-type initial downlink BWPs corresponds to a random access message and another corresponds to a system message.

The method further includes: receiving a paging message in one of the N first-type initial downlink BWPs, and receiving a random access message and a system message in one or two of the K second-type initial downlink BWPs.

Specifically, a random access message and a system message are received in the same second-type initial downlink BWP among the K second-type initial downlink BWPs, or a random access message is received in one second-type initial downlink BWP among the K second-type initial downlink BWPs, and another second-type initial downlink BWP receives a system message.

An embodiment of the present disclosure provides a method of receiving downlink information, which is performed by a first-type terminal, and the method includes: monitoring N first-type initial downlink BWPs, and not monitoring K second-type initial downlink BWPs, where the N is not greater than M, the first-type initial downlink BWPs are initial downlink BWPs specific to the first-type terminal, the N and the M are integers greater than 0, and the M indicates a maximum number of the first-type initial downlink BWPs configurable by a network device for the first-type terminal; the second-type initial downlink BWPs are initial downlink BWPs usable by a second-type terminal, a terminal capacity of the second-type terminal is greater than a terminal capacity of the first-type terminal, and the K is an integer greater than 0.

In some possible implementations, the first-type terminal is a Redcap terminal.

In some possible implementations, the M is not greater than 3.

In some possible implementations, as shown in FIG. 3, the maximum number of first-type initial downlink BWPs that can be configured by the network device for the first-type terminal is 3, where the three first-type initial downlink BWPs that can be configured by the network device for the first-type of terminal are used to send a paging message, to send a random access message, and to send a system message, respectively.

In some possible implementations, the M is 1.

In some possible implementations, configuration information relating to K second-type initial downlink BWPs to be monitored by the first-type terminal is determined according to a definition of a protocol.

In some possible implementations, configuration information relating to K second-type initial downlink BWPs to be monitored by the first-type terminal is configured by the network device.

In some possible implementations, the method further includes: receiving first configuration information sent by the network device, where the first configuration information relates to the N first-type initial downlink BWPs to be monitored by the first-type terminal and the K second-type initial downlink BWPs to be monitored by the first-type terminal; where the N is not greater than M, the first-type initial downlink BWPs are initial downlink BWPs specific to the first-type terminal, the N and the M are integers greater than 0, and the M indicates the maximum number of the first-type initial downlink BWPs configurable by the network device for the first-type terminal. The second-type initial downlink BWPs are initial downlink BWPs usable by a second-type terminal, a terminal capacity of the second-type terminal is greater than a terminal capacity of the first-type terminal, and the K is an integer greater than 0.

An embodiment of the present disclosure provides a method of receiving downlink information, which is performed by a network device. FIG. 8 is a flowchart of a method of monitoring a downlink BWP according to an embodiment of the present disclosure. As shown in FIG. 8, the method includes the following step S801.

At step S801: first configuration information is sent to a first-type terminal, where the first configuration information relates to N first-type initial downlink BWPs to be monitored by the first-type terminal; where the N is not greater than M, the first-type initial downlink BWPs are initial downlink BWPs specific to the first-type terminal, the N and the M are integers greater than 0, and the M indicates the maximum number of the first-type initial downlink BWPs configurable by the network device 101 for the first-type terminal.

In some possible implementations, the first-type terminal is a Redcap terminal. In some possible implementations, the M is not greater than 3.

In some possible implementations, as shown in FIG. 3, the maximum number of first-type initial downlink BWPs that can be configured by the network device for the first-type terminal is 3, where the three first-type initial downlink BWPs that can be configured by the network device for the first-type of terminal are used to send a paging message, to send a random access message, and to send a system message, respectively.

In some possible implementations, the M is 1.

In the embodiment of the present disclosure, the first-type terminal is configured with less first-type initial downlink BWPs that need to be monitored, thereby reducing the complexity of the first-type terminal and saving the power of the first-type terminal.

An embodiment of the present disclosure provides a method of receiving downlink information, which is performed by a network device. FIG. 9 is a flowchart of a method of monitoring a downlink BWP according to an embodiment of the present disclosure. As shown in FIG. 9, the method includes the following steps S901 and S902.

At step S901: first configuration information is sent to a first-type terminal, where the first configuration information relates to N first-type initial downlink BWPs to be monitored by the first-type terminal; where the N is not greater than M, the first-type initial downlink BWPs are initial downlink BWPs specific to the first-type terminal, the N and the M are integers greater than 0, and the M indicates the maximum number of the first-type initial downlink BWPs configurable by the network device 101 for the first-type terminal.

At step S902, at least one of the following messages a system message, a random access message or a paging message is sent in one of the N first-type initial downlink BWPs.

In some possible implementations, the first-type terminal is a Redcap terminal.

In some possible implementations, the M is not greater than 3.

In some possible implementations, as shown in FIG. 3, the maximum number of first-type initial downlink BWPs that can be configured by the network device for the first-type terminal is 3, where the three first-type initial downlink BWPs that can be configured by the network device for the first-type of terminal are used to send a paging message, to send a random access message, and to send a system message, respectively.

In some possible implementations, the M is 1.

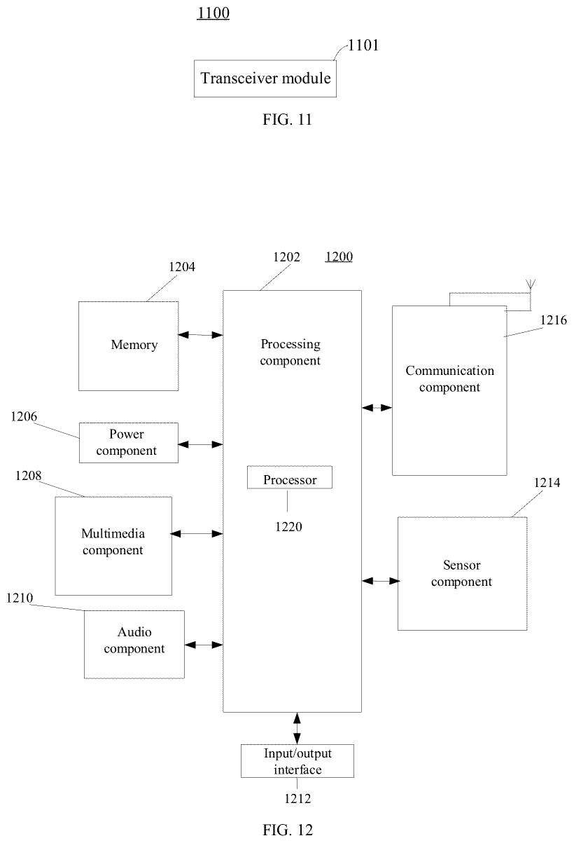

An embodiment of the present disclosure provides a method of receiving downlink information, which is performed by a network device. FIG. 10 is a flowchart of a method of monitoring a downlink BWP according to an embodiment of the present disclosure. As shown in FIG. 10, the method includes the following step S1001.

At step S1001: first configuration information is sent to a first-type terminal, where the first configuration information relates to N first-type initial downlink BWPs and K second-type initial downlink BWPs to be monitored by the first-type terminal; where the N is not greater than M, the first-type initial downlink BWPs are initial downlink BWPs specific to the first-type terminal, the N and the M are integers greater than 0, and the M indicates the maximum number of the first-type initial downlink BWPs configurable by the network device 101 for the first-type terminal. The second-type initial downlink BWPs are initial downlink BWPs usable by a second-type terminal, a terminal capacity of the second-type terminal is greater than a terminal capacity of the first-type terminal, and the K is an integer greater than 0.

In some possible implementations, the first-type terminal is a Redcap terminal.

In some possible implementations, the M is not greater than 3.

In some possible implementations, as shown in FIG. 3, the maximum number of first-type initial downlink BWPs that can be configured by the network device for the first-type terminal is 3, where the three first-type initial downlink BWPs that can be configured by the network device for the first-type of terminal are used to send a paging message, to send a random access message, and to send a system message, respectively.

In some possible implementations, the M is 1.

In some possible implementations, the K is not greater than 1.

In some possible implementations, the method further includes: sending, in one of the N first-type initial downlink BWPs, at least one of following messages: a system message, a random access message, or a paging message.

In some possible implementations, the method further includes: sending, in one of the K second-type initial downlink BWPs, at least one of following messages: a system message, a random access message, or a paging message.

In some possible implementations, a random access message is sent in one of the N first-type initial downlink BWPs, and a system message and a paging message are sent in one or two of the K second-type initial downlink BWPs.

In some possible implementations, a random access message and a paging message are sent in one of the N first-type initial downlink BWPs, and a system message is sent in one of the K second-type initial downlink BWPs.

In some possible implementations, a random access message and a paging message are respectively sent in two of the N first-type initial downlink BWPs, and a system message is sent in one of the K second-type initial downlink BWPs.

In some possible implementations, a paging message is sent in one of the N first-type initial downlink BWPs, and a random access message and a system message are sent in one or two of the K second-type initial downlink BWPs.

In some possible implementations, at least one of following messages: a system message, a random access message or a paging message is sent in at least one of the N first-type initial downlink BWPs; and any one of following messages: a system message, a random access message, and a paging message are not sent in the second-type initial downlink BWPs.

Based on the same concept as the described method embodiments, an embodiment of the present disclosure further provides a communication apparatus, which can have the functions of the user equipment 102 in the method embodiments, and is configured to perform the steps provided in the embodiments to be performed by the user equipment 102. These functions can be realized by hardware, or by software or hardware executing corresponding software. The hardware or software includes one or more modules corresponding to the described functions.

In a possible implementation, the communication apparatus 1100 shown in FIG. 11 can be used as the user equipment 102 involved in the described method embodiments, and can perform the steps performed by the user equipment 102 in the method embodiments.

The communication apparatus 1100 includes a transceiver module 1101, configured to monitor N first-type initial downlink BWPs, where the N is greater M, the first-type initial downlink BWPs are initial downlink BWPs specific to the first-type terminal, the N and the M are integers greater than 0, and the M indicates a maximum number of the first-type initial downlink BWPs configurable by a network device for the first-type terminal.

In some possible implementations, the M is not greater than 3.

In some possible implementations, the M is 1.

In some possible implementations, the transceiver module 1101 is further configured to receive, in one of the N first-type initial downlink BWPs, at least one of following messages: a system message, a random access message, or a paging massage.

In some possible implementations, the transceiver module 1101 is further configured to receive first configuration information sent by the network device, where the first configuration information relates to the N first-type initial downlink BWPs to be monitored by the first-type terminal; where the N is not greater than the M, the first-type initial downlink BWPs are initial downlink BWPs specific to the first-type terminal, the N and the M are integers greater than 0, and the M indicates the maximum number of the first-type initial downlink BWPs configurable by the network device for the first-type terminal.

In some possible implementations, the transceiver module 1101 is further configured to monitor K second-type initial downlink BWPs, where the second-type initial downlink BWPs are initial downlink BWPs usable by a second-type terminal, a terminal capacity of the second-type terminal is greater than a terminal capacity of the first-type terminal, and the K is an integer greater than 0.

In some possible implementations, the K is not greater than 1.

In some possible implementations, the transceiver module 1101 is further configured to receive, in one of the N first-type initial downlink BWPs, at least one of following messages: a system message, a random access message, or a paging message; or receive, in one of the K second-type initial downlink BWPs, at least one of following messages: a system message, a random access message, or a paging message.

In some possible implementations, the transceiver module 1101 is further configured to receive a random access message in one of the N first-type initial downlink BWPs, and receive a system message and a paging message in one or two of the K second-type initial downlink BWPs.

In some possible implementations, the transceiver module 1101 is further configured to receive a random access message and a paging message in one of the N first-type initial downlink BWPs, and receive a system message in one of the K second-type initial downlink BWPs.

In some possible implementations, the transceiver module 1101 is further configured to receive a random access message and a paging message in two of the N first-type initial downlink BWPs respectively, and receive a system message in one of the K second-type initial downlink BWPs.

In some possible implementations, the transceiver module 1101 is further configured to receive a paging message in one of the N first-type initial downlink BWPs, and receive a random access message and a system message in one or two of the K second-type initial downlink BWPs.

In some possible implementations, the transceiver module 1101 is further configured to receive, in at least one of the N first-type initial downlink BWPs, at least one of following messages: a system message, a random access message, or a paging massage; and not monitoring K second-type initial downlink BWPs, where the second-type initial downlink BWPs are initial downlink BWPs usable by a second-type terminal, a terminal capacity of the second-type terminal is greater than a terminal capacity of the first-type terminal, and the K is an integer greater than 0.

In some possible implementations, the first configuration information further relates to K second-type initial downlink BWPs to be monitored by the first-type terminal, where the second-type initial downlink BWPs are initial downlink BWPs usable by a second-type terminal, a terminal capacity of the second-type terminal is greater than a terminal capacity of the first-type terminal, and the K is an integer greater than 0.

FIG. 12 is a block diagram of an apparatus 1200 for monitoring an initial downlink BWP according to an embodiment of the present disclosure. For example, the apparatus 1200 may be a mobile phone, a computer, a digital broadcasting terminal, a messaging device, a game console, a tablet device, a medical device, a fitness device, a personal digital assistant, etc.

Referring to FIG. 12, the apparatus 1200 may include one or more of the following components: a processing component 1202, a memory 1204, a power component 1206, a multimedia component 1208, an audio component 1210, an input/output (I/O) interface 1212, a sensor component 1214, and a communication component 1216.

The processing component 1202 generally controls the overall operation of the apparatus 1200, such as operations associated with display, telephone call, data communication, camera operation and recording operation. The processing component 1202 may include one or more processors 1220 to execute instructions to complete all or part of steps of the described methods. In addition, the processing component 1202 may include one or more modules to facilitate interactions between the processing component 1202 and other components. For example, the processing component 1202 may include a multimedia module to facilitate interactions between the multimedia component 1208 and the processing component 1202.

The memory 1204 is configured to store various types of data to support operations in the apparatus 1200. Examples of these data include instructions of any application program or method for being operated on the apparatus 1200, contact data, phone book data, messages, pictures, videos, etc. The memory 1204 can be implemented by any type of volatile or non-volatile memory device or combinations thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

The power component 1206 provides power to various components of the apparatus 1200. The power component 1206 may include a power management system, one or more power supplies, and other components associated with generating, managing and distributing power for the apparatus 1200.

The multimedia component 1208 includes a screen that provides an output interface between the apparatus 1200 and a user. In some embodiments, the screen may include a liquid crystal display (LCD) and a touch panel (TP). If the screen includes a touch panel, the screen may be implemented as a touch screen to receive an input signal from a user. The touch panel includes one or more touch sensors to sense touching, sliding and gestures on the touch panel. The touch sensor may not only sense a boundary of a touching or sliding action, but also detect a duration and a pressure related to the touching or sliding operation. In some embodiments, the multimedia component 1208 includes a front camera and/or a rear camera. When the apparatus 1200 is in an operation mode, such as a shooting mode or a video mode, the front camera and/or the rear camera can receive external multimedia data. Each front camera and rear camera may be a fixed optical lens system or have focal length and optical zoom capability.

The audio component 1210 is configured to output and/or input audio signals. For example, the audio component 1210 includes a microphone (MIC) configured to receive external audio signals when the apparatus 1200 is in the operation mode, such as a calling mode, a recording mode and a voice recognition mode. The received audio signal may be further stored in the memory 1204 or transmitted via the communication component 1216. In some embodiments, the audio component 1210 further includes a speaker for outputting audio signals.

The I/O interface 1212 provides an interface between the processing component 1202 and peripheral interface modules, where the peripheral interface modules may be keyboards, click-wheels, buttons, etc. These buttons may include, but are not limited to: home button, volume button, start button and lock button.

The sensor component 1214 includes one or more sensors for providing various aspects of state evaluation for the apparatus 1200. For example, the sensor component 1214 can detect an on/off state of the apparatus 1200, a relative positioning of components, for example, the components are the display and the keypad of the apparatus 1200, and the sensor component 1214 can also detect a position change of the apparatus 1200 or a component of the apparatus 1200, presence or absence of user contact with the apparatus 1200, orientation or acceleration/deceleration of the apparatus 1200 and a temperature change of the apparatus 1200. The sensor component 1214 may include a proximity sensor configured to detect presence of a nearby object without any physical contact. The sensor component 1214 may also include an optical sensor, such as a CMOS or CCD image sensor, for use in imaging applications. In some embodiments, the sensor component 1214 may further include an acceleration sensor, a gyroscope sensor, a magnetic sensor, a pressure sensor or a temperature sensor.

The communication component 1216 is configured to facilitate wired or wireless communication between the apparatus 1200 and other devices. The apparatus 1200 can access a wireless network based on communication standards, such as WiFi, 4G or 5G, or combinations thereof. In an embodiment of the present disclosure, the communication component 1216 receives a broadcast signal or broadcast related information from an external broadcast management system via a broadcast channel. In an embodiment of the present disclosure, the communication component 1216 further includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an embodiment of the present disclosure, the apparatus 1200 may be implemented by one or more application-specific integrated circuits (ASIC), digital signal processors (DSP), digital signal processing devices (DSPD), programmable logic devices (PLD), field programmable gate arrays (FPGA), controllers, micro-controllers, micro-processors or other electronic components, for executing the described method.

In an embodiment of the present disclosure, a non-transitory computer-readable storage medium is further provided, such as the memory 1204 including instructions, where the instructions can be executed by a processor 1220 of the apparatus 1200 to complete the described method. For example, the non-transitory computer-readable storage medium may be an ROM, a random access memory (RAM), a CD-ROM, a magnetic tape, a floppy disk, an optical data storage device, etc.

Based on the same concept as the method embodiments, an embodiment of the present disclosure further provides a communication apparatus, which can have the functions of the network device 101 in the described method embodiments, and is configured to perform the steps provided in the embodiments to be performed by the network device 101. These functions can be realized by hardware, or by software or hardware executing corresponding software. The hardware or software includes one or more modules corresponding to the functions.

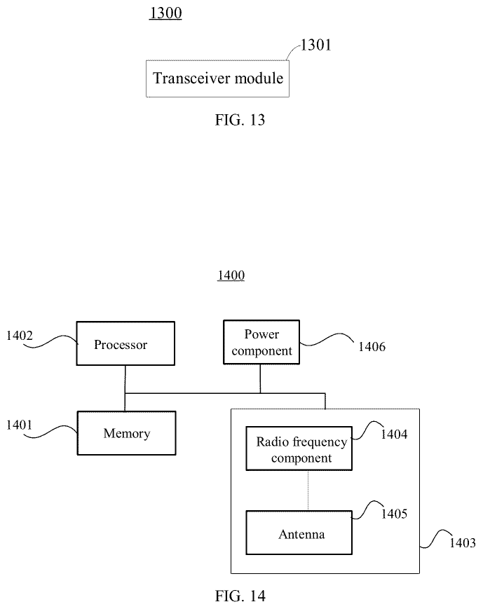

In a possible implementation, the communication apparatus 1300 shown in FIG. 13 can be used as the network device 101 involved in the described method embodiments, and performs the steps performed by the network device 101 in the described method embodiments.

The communication apparatus 1300 includes a transceiver module 1301, configured to send first configuration information to a first-type terminal, where the first configuration information relates to N first-type initial downlink BWPs to be monitored by the first-type terminal; where the N is not greater than M, the first-type initial downlink BWPs are initial downlink BWPs specific to the first-type terminal, the N and the M are integers greater than 0, and the M indicates a maximum number of the first-type initial downlink BWPs configurable by the network device for the first-type terminal.

In a possible implementation, the M is not greater than 3.

In a possible implementation, the M is 1.

In a possible implementation, the transceiver module 1301 is further configured to send, in one of the N first-type initial downlink BWPs, at least one of following messages: a system message, a random access message, or a paging message.

In a possible implementation, the first configuration information further relates to K second-type initial downlink BWPs to be monitored by the first-type terminal, where the second-type initial downlink BWPs are initial downlink BWPs usable by a second-type terminal, a terminal capacity of the second-type terminal is greater than a terminal capacity of the first-type terminal, and the K is an integer greater than 0.

In a possible implementation, the K is not greater than 1.

In a possible implementation, the transceiver module 1301 is further configured to send, in one of the N first-type initial downlink BWPs, at least one of following messages: a system message, a random access message, or a paging message; or send, in one of the K second-type initial downlink BWPs, at least one of following messages: a system message, a random access message, or a paging message.

In a possible implementation, the transceiver module 1301 is further configured to send a random access message in one of the N first-type initial downlink BWPs, and send a system message and a paging message in one or two of the K second-type initial downlink BWPs.

In a possible implementation, the transceiver module 1301 is further configured to send a random access message and a paging message in one of the N first-type initial downlink BWPs, and send a system message in one of the K second-type initial downlink BWPs.

In a possible implementation, the transceiver module 1301 is further configured to send a random access message and a paging message in two of the N first-type initial downlink BWPs respectively, and send a system message in one of the K second-type initial downlink BWPs.

In a possible implementation, the transceiver module 1301 is further configured to send a paging message in one of the N first-type initial downlink BWPs, and send a random access message and a system message in one or two of the K second-type initial downlink BWPs.

In a possible implementation, the transceiver module 1301 is further configured to send, in at least one of the N first-type initial downlink BWPs, at least one of following messages: a system message, a random access message or a paging message; and not send, in the second-type initial downlink BWPs, any one of following messages: a system message, a random access message, and a paging message.

When the communication apparatus is a network device, the structure can further be as shown in FIG. 14. The structure of the communication apparatus will be described by taking the network device 101 as an example. As shown in FIG. 14, the apparatus 1400 includes a memory 1401, a processor 1402, a transceiver component 1403, and a power component 1406 communicatively connected to each other. The memory 1401 is coupled with the processor 1402 and can be configured to store programs and data necessary for the communication apparatus 1400 to implement various functions. The processor 1402 is configured to support the communication apparatus 1400 to perform the corresponding function in the described methods, which can be realized by calling the programs stored in the memory 1401. The transceiver component 1403 can be a wireless transceiver, which can be configured to support the communication apparatus 1400 to receive signaling and/or data and send signaling and/or data through a wireless air interface. The transceiver component 1403 can also be named as a transceiver unit or a communication unit. The transceiver component 1403 can include a radio frequency component 1404 and one or more antennas 1405, where the radio frequency component 1404 can be a remote radio unit (RRU), which can be used for the transmission of radio frequency signals and the conversion between radio frequency signals and baseband signals, and the one or more antennas 1405 can be used for the radiation and reception of radio frequency signals.

When the communication apparatus 1400 needs to transmit data, the processor 1402 can perform baseband processing on the to-be-transmitted data, and then output a baseband signal to a radio frequency unit, and the radio frequency unit performs radio frequency processing on the baseband signal and then transmits the radio frequency signal in the form of electromagnetic waves through the antenna. When data is sent to the communication apparatus 1400, the radio frequency unit receives the radio frequency signal through the antenna, converts the radio frequency signal into a baseband signal, and outputs the baseband signal to the processor 1402, which converts the baseband signal into data and processes the data.

The present disclosure provides a method, apparatus, and a readable storage medium for monitoring a downlink bandwidth part.

In a first aspect, a method of monitoring a downlink bandwidth part (BWP) is provided, which is performed by a first-type terminal, including: monitoring N first-type initial downlink BWPs, where the N is not greater than M, the first-type initial downlink BWPs are initial downlink BWPs specific to the first-type terminal, the N and the M are integers greater than 0, and the M indicates a maximum number of the first-type initial downlink BWPs configurable by a network device for the first-type terminal.

In this method, the first-type initial downlink BWPs to be monitored by the first-type terminal are reduced, thereby reducing the complexity of the first-type terminal and saving the power of the first-type terminal.

In some possible implementations, the M is not greater than 3.

In some possible implementations, the M is 1.

In some possible implementations, the method further includes: receiving, in one of the N first-type initial downlink BWPs, at least one of following messages: a system message, a random access message, or a paging message.

In some possible implementations, the method further includes: monitoring K second-type initial downlink BWPs, where the second-type initial downlink BWPs are initial downlink BWPs usable by a second-type terminal, a terminal capacity of the second-type terminal is greater than a terminal capacity of the first-type terminal, and the K is an integer greater than 0.

In some possible implementations, the K is not greater than 1.

In some possible implementations, the method further includes: receiving, in one of the N first-type initial downlink BWPs, at least one of following messages: a system message, a random access message, or a paging massage; or, receiving, in one of the K second-type initial downlink BWPs, at least one of following messages: a system message, a random access message, or a paging message.

In some possible implementations, the method further includes: receiving a random access message in one of the N first-type initial downlink BWPs, and receiving a system message and a paging message in one or two of the K second-type initial downlink BWPs.

In some possible implementations, the method further includes: receiving a random access message and a paging message in one of the N first-type initial downlink BWPs, and receiving a system message in one of the K second-type initial downlink BWPs.

In some possible implementations, the method further includes: receiving a random access message and a paging message in two of the N first-type initial downlink BWPs respectively, and receiving a system message in one of the K second-type initial downlink BWPs.

In some possible implementations, the method further includes: receiving a paging message in one of the N first-type initial downlink BWPs, and receiving a random access message and a system message in one or two of the K second-type initial downlink BWPs.

In some possible implementations, the method further includes: receiving, in one of the N first-type initial downlink BWPs, at least one of following messages: a system message, a random access message, or a paging massage; and not monitoring K second-type initial downlink BWPs.

In a second aspect, a method of monitoring a downlink BWP is provided, which is performed by a network device, including: sending first configuration information to a first-type terminal, where the first configuration information relates to N first-type initial downlink BWPs to be monitored by the first-type terminal; where the N is not greater than M, the first-type initial downlink BWPs are initial downlink BWPs specific to the first-type terminal, the N and the M are integers greater than 0, and the M indicates a maximum number of first-type initial downlink BWPs configurable by the network device for the first-type terminal.

In this method, the first-type terminal is configured with less first-type initial downlink BWPs that need to be monitored, thereby reducing the complexity of the first-type terminal and saving the power of the first-type terminal.

In some possible implementations, the M is not greater than 3.

In some possible implementations, the M is 1.

In some possible implementations, the method further includes: sending, in one of the N first-type initial downlink BWPs, at least one of following messages: a system message, a random access message, or a paging massage.

In some possible implementations, the method further includes: the first configuration information further relates to K second-type initial downlink BWPs to be monitored by the first-type terminal, where the second-type initial downlink BWPs are initial downlink BWPs usable by a second-type terminal, a terminal capacity of the second-type terminal is greater than a terminal capacity of the first-type terminal, and the K is an integer greater than 0.

In some possible implementations, the K is not greater than 1.

In some possible implementations, the method further includes: sending, in one of the N first-type initial downlink BWPs, at least one of following messages: a system message, a random access message, or a paging message; or, sending, in one of the K second-type initial downlink BWPs, at least one of following messages: a system message, a random access message, or a paging message.

In some possible implementations, the method further includes: the first configuration information relates to sending a random access message in one of the N first-type initial downlink BWPs, and sending a system message and a paging message in one or two of the K second-type initial downlink BWPs.

In some possible implementations, the method further includes: the first configuration information relates to sending a random access message and a paging message in one of the N first-type initial downlink BWPs, and sending a system message in one of the K second-type initial downlink BWPs.

In some possible implementations, the method further includes: the first configuration information relates to sending a random access message and a paging message respectively in two of the N first-type initial downlink BWPs, and sending a system message in one of the K second-type initial downlink BWPs.

In some possible implementations, the method further includes: the first configuration information relates to sending a paging message in one of the N first-type initial downlink BWPs, and sending a random access message and a system message in one or two of the K second-type initial downlink BWPs.

In some possible implementations, the method further includes: the first configuration information relates to sending, in at least one of the N first-type initial downlink BWPs, at least one of following messages: a system message, a random access message or a paging message; and not sending, in the second-type initial downlink BWPs, any one of following messages: a system message, a random access message, and a paging message.

In a third aspect, a communication apparatus is provided. The communication apparatus can be configured to perform the steps performed by the user equipment in the first aspect or any possible design of the first aspect. The user equipment can realize the functions in the included methods through a hardware structure, a software module, or a hardware structure plus a software module.

When the communication apparatus shown in the first aspect is realized by a software module, the communication apparatus may include a processing module.

The processing module is configured to monitor N first-type initial downlink BWPs, where the N is less than M, the first-type initial downlink BWPs are initial downlink BWPs specific to the first-type terminal, the N and the M are integers greater than 0, and the M indicates a maximum number of the first-type initial downlink BWPs configurable by a network device for the first-type terminal.

In a fourth aspect, a communication apparatus is provided. The communication apparatus can be configured to perform the steps performed by the network device in the second aspect or any possible design of the second aspect. The network device can realize the functions in the methods through a hardware structure, a software module, or a hardware structure plus a software module.

When the communication apparatus shown in the second aspect is realized by a software module, the communication apparatus may include a transceiver module.

When executing the steps described in the second aspect, the transceiver module is configured to send first configuration information to a first-type terminal, where the first configuration information relates to N first-type initial downlink BWPs; where the N is less than M, the first-type initial downlink BWPs are initial downlink BWPs specific to the first-type terminal, the N and the M are integers greater than 0, and the M indicates a maximum number of the first-type initial downlink BWPs configurable by the network device for the first-type terminal.

In a fifth aspect, a communication apparatus is provided, including a processor and a memory, the memory is configured to store a computer program, and the processor is configured to execute the computer program to realize the first aspect or any possible design of the first aspect.

In a sixth aspect, a communication apparatus is provided, including a processor and a memory, the memory is configured to store a computer program, and the processor is configured to execute the computer program to realize the second aspect or any possible design of the second aspect.

In a seventh aspect, a non-transitory computer-readable storage medium is provided, in which instructions (or named as computer programs, programs) are stored, which, when called for execution on a computer, cause the computer to execute the first aspect or any possible design of the first aspect.

In an eighth aspect, a non-transitory computer-readable storage medium is provided, in which instructions (or named as computer programs, programs) are stored, which, when called for execution on a computer, cause the computer to execute the second aspect or any possible design of the second aspect.

Other implementations of the embodiments of the present disclosure will easily occur to those skilled in the art after considering the specification and practicing the present disclosure disclosed herein. The present disclosure is intended to cover any variations, uses or adaptations of the embodiments of the present disclosure, and these variations, uses or adaptations follow general principles of the embodiments of the present disclosure and include common sense or common technical means in the technical field that are not disclosed in the present disclosure. The specification and embodiments are to be regarded as exemplary only, and true scope and spirit of the embodiments of the present disclosure are indicated by the following claims.

It should be understood that the embodiments of the present disclosure are not limited to precise structures described herein and shown in the accompanying drawings, and various modifications and changes can be made without departing from its scope. The scope of the embodiments of the present disclosure is limited only by the appended claims.

### INDUSTRIAL APPLICABILITY

First-type initial downlink BWPs that need to be monitored by a first-type terminal are reduced, such that the complexity of the first-type terminal is reduced, and the power of the first-type terminal is saved on.

1. A method of monitoring a downlink bandwidth part (BWP), performed by a first-type terminal and comprising:
monitoring N first-type initial downlink BWPs, wherein the N is not greater than M, the first-type initial downlink BWPs are initial downlink BWPs specific to the first-type terminal, the N and the M are integers greater than 0, and the M indicates a maximum number of the first-type initial downlink BWPs configurable by a network device for the first-type terminal.

2. The method according to claim 1, wherein the M is not greater than 3.

3. (canceled)

4. The method according to claim 1, further comprising:
receiving, in one of the N first-type initial downlink BWPs, at least one of following messages: a system message, a random access message, or a paging message.

5. The method according to claim 1, further comprising:
receiving first configuration information sent by the network device, wherein the first configuration information relates to the N first-type initial downlink BWPs to be monitored by the first-type terminal.

6. The method according to claim 1, further comprising:
monitoring K second-type initial downlink BWPs, wherein the second-type initial downlink BWPs are initial downlink BWPs usable by a second-type terminal, a terminal capacity of the second-type terminal is greater than a terminal capacity of the first-type terminal, and the K is an integer greater than 0.

7. (canceled)

8. The method according to claim 6, further comprising:
receiving, in one of the N first-type initial downlink BWPs, at least one of following messages: a system message, a random access message, or a paging massage; or
receiving, in one of the K second-type initial downlink BWPs, at least one of following messages: a system message, a random access message, or a paging message.

9. The method according to claim 6, further comprising:
receiving a random access message in one of the N first-type initial downlink BWPs, and
receiving a system message and a paging message in one or two of the K second-type initial downlink BWPs.

10. The method according to claim 6, further comprising:
receiving a random access message and a paging message in one of the N first-type initial downlink BWPs, and receiving a system message in one of the K second-type initial downlink BWPs; or
receiving a random access message and a paging message in two of the N first-type initial downlink BWPs respectively, and receiving a system message in one of the K second-type initial downlink BWPs.

11. (canceled)

12. The method according to claim 6, further comprising:
receiving a paging message in one of the N first-type initial downlink BWPs, and
receiving a random access message and a system message in one or two of the K second-type initial downlink BWPs.

13. The method according to claim 1, further comprising:
receiving, in at least one of the N first-type initial downlink BWPs, at least one of following messages: a system message, a random access message, or a paging massage; and
not monitoring K second-type initial downlink BWPs, wherein the second-type initial downlink BWPs are initial downlink BWPs usable by a second-type terminal, a terminal capacity of the second-type terminal is greater than a terminal capacity of the first-type terminal, and the K is an integer greater than 0.

14. The method according to claim 5, wherein,
the first configuration information further relates to K second-type initial downlink BWPs to be monitored by the first-type terminal, wherein the second-type initial downlink BWPs are initial downlink BWPs usable by a second-type terminal, a terminal capacity of the second-type terminal is greater than a terminal capacity of the first-type terminal, and the K is an integer greater than 0.

15. A method of monitoring a downlink bandwidth part (BWP), performed by a network device and comprising:
sending first configuration information to a first-type terminal, wherein the first configuration information relates to N first-type initial downlink BWPs to be monitored by the first-type terminal; wherein the N is not greater than M, the first-type initial downlink BWPs are initial downlink BWPs specific to the first-type terminal, the N and the M are integers greater than 0, and the M indicates a maximum number of the first-type initial downlink BWPs configurable by the network device for the first-type terminal.

16. The method according to claim 15, wherein the M is not greater than 3.

17. (canceled)

18. The method according to claim 15, further comprising:
sending, in one of the N first-type initial downlink BWPs, at least one of following messages: a system message, a random access message, or a paging massage.

19. The method according to claim 15, wherein,
the first configuration information further relates to K second-type initial downlink BWPs to be monitored by the first-type terminal, wherein the second-type initial downlink BWPs are initial downlink BWPs usable by a second-type terminal, a terminal capacity of the second-type terminal is greater than a terminal capacity of the first-type terminal, and the K is an integer greater than 0.

20. (canceled)

21. The method according to claim 19, further comprising:
sending, in one of the N first-type initial downlink BWPs, at least one of following messages: a system message, a random access message, or a paging message; or
sending, in one of the K second-type initial downlink BWPs, at least one of following messages: a system message, a random access message, or a paging message.

22. The method according to claim 19, further comprising:
sending a random access message in one of the N first-type initial downlink BWPs, and sending a system message and a paging message in one or two of the K second-type initial downlink BWPs, or
sending a random access message and a paging message in one of the N first-type initial downlink BWPs, and sending a system message in one of the K second-type initial downlink BWPs, or
sending a random access message and a paging message in two of the N first-type initial downlink BWPs respectively, and sending a system message in one of the K second-type initial downlink BWPs, or
sending a paging message in one of the N first-type initial downlink BWPs, and sending a random access message and a system message in one or two of the K second-type initial downlink BWPs.

23-25. (canceled)

26. The method according to claim 19, further comprising:
sending, in at least one of the N first-type initial downlink BWPs, at least one of following messages: a system message, a random access message or a paging message; and
not sending, in the second-type initial downlink BWPs, any one of following messages: a system message, a random access message, and a paging message.

27-28. (canceled)

29. A communication apparatus, comprising a processor and a memory, wherein,
the memory is configured to store computer programs; and
the processor is configured to execute the computer programs to implement:
monitoring N first-type initial downlink bandwidth parts (BWPs), wherein the N is not greater than M, the first-type initial downlink BWPs are initial downlink BWPs specific to a first-type terminal, the N and the M are integers greater than 0, and the M indicates a maximum number of the first-type initial downlink BWPs configurable by a network device for the first-type terminal.

30. A communication apparatus, comprising a processor and a memory, wherein
the memory is configured to store computer programs; and
the processor is configured to execute the computer programs to implement the method according to claim 15.

31-32. (canceled)
